(19) United States
(12) Patent Application Publication
(10) Pub. No.: US 2014/0358668 A1
(43) Pub. Date: Dec. 4, 2014

(54) SYSTEM AND METHOD FOR INTEGRATING SUPPLEMENTAL CONTENT WITHIN A WEBPAGE

(71) Applicants: Dan Fredinburg, San Francisco, CA (US); Andrew Swerdlow, San Francisco, CA (US)

(72) Inventors: Dan Fredinburg, San Francisco, CA (US); Andrew Swerdlow, San Francisco, CA (US)

(73) Assignee: Google Inc., Mountain View, CA (US)

(21) Appl. No.: 13/558,032

(22) Filed: Jul. 25, 2012

(51) Int. Cl. G06Q 30/02

(52) U.S. Cl. 705/14.43; 705/14.73; 705/14.66

(57) ABSTRACT

This specification describes technologies relating to content presentation. In general, one aspect of the subject matter described in this specification can be embodied in methods that include the actions of deploying a first arrangement of supplemental content items across one or more ad slots of a webpage, determining one or more interactions in relation to the webpage, processing, with a processor executing code, the one or more interactions to identify a collective distribution of attention across the webpage, generating, based on the collective distribution, one or more additional arrangements of supplemental content items, and deploying at least one of the one or more additional arrangements across the one or more ad slots of the webpage. Other embodiments of the various aspects include corresponding systems, apparatus, and computer program products.

### BACKGROUND

The present disclosure relates to content presentation.

Advertisers provide content such as advertisements in different forms in order to attract consumers. An advertisement (“ad”) is a piece of information designed to be used in whole or part by a user, for example, a particular consumer. Ads can be provided in electronic form. For example, online ads can be provided as banner ads on a web page, as ads presented with search results, or as ads presented in a mobile application.

One can refer to the inclusion of an ad in a medium, e.g., a webpage or a mobile application, as an impression. An advertising system can include an ad in a webpage, for example, in response to one or more keywords in a user search query input to a search engine. If a user selects the presented ad (e.g., by “clicking” the ad), the user is generally taken to another location associated with the ad, for example, to another, particular web page.

Content such as advertisements can be allocated through an auction process. For example, advertisers can provide bids specifying amounts that the advertisers are respectively willing to pay for presentation of their advertisements. In turn, an auction can be performed and advertisement slots (e.g., locations on a web page or within a mobile application) can be allocated to advertisers according to their bids. When one advertisement slot is being allocated in the auction, the advertisement slot can be allocated to the advertiser that provided the highest bid or a highest auction score (e.g., a score that is computed as a function of a bid and/or an advertisement quality measure). When multiple advertisement slots are allocated in a single auction, the advertisement slots can be allocated to a set of bidders that provided the highest bids or have the highest auction scores.

### SUMMARY

This specification describes technologies relating to content presentation.

In general, one aspect of the subject matter described in this specification can be embodied in methods for integrating content within a webpage. The method includes the actions of deploying a first arrangement of supplemental content items across one or more ad slots of a webpage, determining one or more interactions in relation to the webpage, processing, with a processor executing code, the one or more interactions to identify a collective distribution of attention across the webpage, generating, based on the collective distribution, one or more additional arrangements of supplemental content items, and deploying at least one of the one or more additional arrangements across the one or more ad slots of the webpage.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a diagram of an example content presentation system.

FIG. 2 is a block diagram of an example system for integrating content within a webpage.

FIG. 3 is a flow chart of an example process integrating content within a webpage.

FIG. 4A is an exemplary screenshot reflecting an exemplary webpage.

FIG. 4B is an exemplary screenshot, showing locations of one or more user clicks across a webpage.

FIG. 4C is an exemplary screenshot, showing locations and degrees of intensity of cursor movements/hovering across a webpage.

FIG. 4D is an exemplary screenshot, showing ‘heatmaps’ reflecting locations and degrees of intensity of user eye movement across a webpage.

FIG. 4E is an exemplary screenshot, showing areas of exposure within a webpage, as reflected by various instances of scrolling.

FIG. 4F is an exemplary screenshot of a webpage, indicating the click-through rate (CTR) of the various ad slots containing ads as deployed across the webpage.

FIG. 5 is an exemplary screenshot of a webpage overlaid with a depiction of the collective distribution of attention across the page.

FIG. 6A is an exemplary screenshot of an arrangement of supplemental content items within a webpage.

FIG. 6B is an exemplary screenshot of a webpage indicating the click-through rate (CTR) of the various ad slots containing ads as deployed across the webpage.

FIG. 6C is an exemplary screenshot of an arrangement of supplemental content items within a webpage, also indicating the click-through rate (CTR) of each of the ad slots within the arrangement in which ads are deployed.

FIG. 7A is an exemplary screenshot of a webpage having a supplemental content item, the webpage being overlaid with a depiction of the collective distribution of attention corresponding to User Profile A.

FIG. 7B is an exemplary screenshot of an arrangement of supplemental content items generated on account of the lack of attention reflected in FIG. 7A.

FIG. 7C is an exemplary screenshot of a webpage having a supplemental content item, the webpage being overlaid with a depiction of the collective distribution of attention corresponding to User Profile B.

FIG. 7D is an exemplary screenshot of an arrangement of supplemental content items generated on account of the lack of attention reflected in FIG. 7C.

FIGS. 8A-C illustrate an exemplary deployment scheme whereby arrangements of supplemental content items are configured to deploy at dynamically adjusted time intervals.

FIGS. 8D-F illustrate an exemplary deployment scheme whereby arrangements of supplemental content items are configured to deploy at dynamically changing locations within a webpage.

FIG. 9 shows an example of a computing device and a mobile computing device that can be used in connection with computer-implemented methods and systems described in the present specification.

Like reference symbols in the various drawings indicate like elements.

### DETAILED DESCRIPTION

By way of overview and introduction, in many webpages, certain areas such as along the top and right-hand sides of the page, are frequently reserved for the insertion of ads. On account of the placement of poor quality ads in these spaces, it has been observed that, over time, website visitors or users have become conditioned to pay little attention to the areas of a webpage where ads traditionally appear. As a result, such visitors may come to ignore ads which may actually be of interest/relevance to them.

In an effort to increase user attention across all areas of a webpage, including areas in which ads are traditionally placed, various supplemental content items can be inserted into such spaces that are otherwise reserved for ads. Various types of interactions with the webpage (e.g., clicks, cursor movements, etc.) can be determined in order to identify the areas of the page that do (or do not) draw the attention of a website user. Based on this identification, additional arrangements and configurations of supplemental content items can be generated in an effort to more evenly distribute the attention of the user across the webpage, even to those areas that the user might have otherwise been inclined to ignore. In doing so, the website user can benefit from increased engagement with additional areas of the webpage, while the content provider and advertiser can benefit on account of the expected increase in attention to those ads that are displayed on the page.

While reference will be made below to advertising systems and processes, other forms of content including other forms of sponsored content can be managed and presented in accordance with the description below.

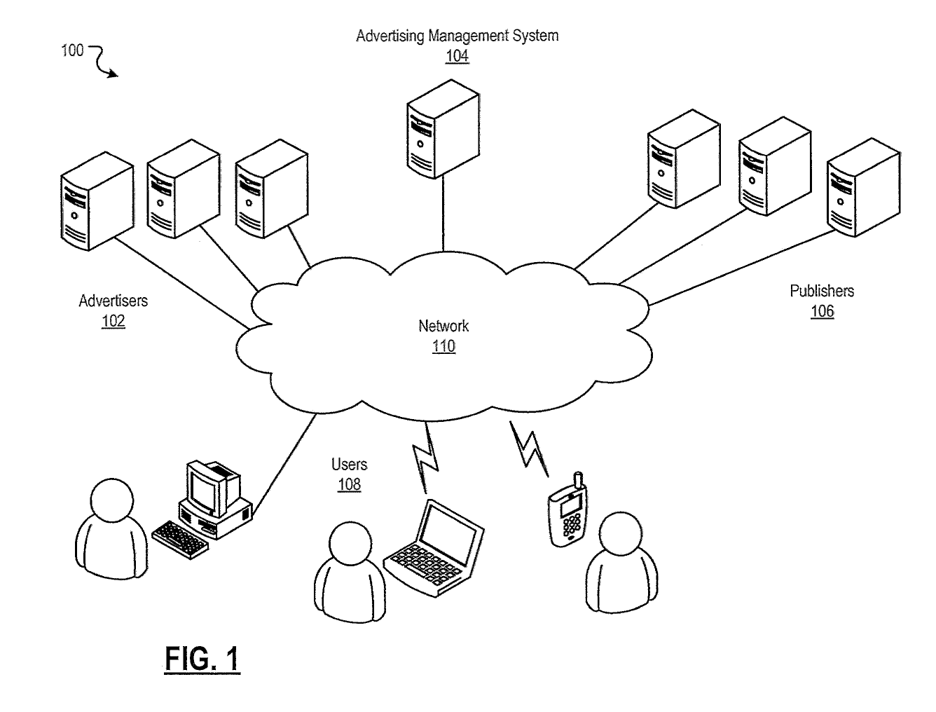

FIG. 1 is a block diagram showing an example content presentation system 100. In some implementations, one or more advertisers 102 can directly, or indirectly, enter, maintain, and log ad information in an advertising management system 104. Though reference is made to advertising, other forms of content, including other forms of sponsored content, can be delivered by the system 100. The ads can be in the form of graphical ads, such as banner ads, text-only ads, image ads, audio ads, video ads, ads combining one or more of any of such components, etc. The ads can also include embedded information, such as links, meta-information, and/or machine executable instructions.

One or more publishers 106 can submit requests for ads to the system 104. The system 104 responds by sending ads to the requesting publisher 106 for placement on, or association with, one or more of the publisher's content items (e.g., web properties such as web pages). It should also be understood that in certain implementations, ads can be provided in a substantially similar manner in television and radio advertising slots, and/or print media space.

Other entities, such as users 108 and the advertisers 102, can provide usage information to the system 104, such as, for example, whether or not a conversion (e.g., a purchase or other interaction including, for example, a request for driving directions to a location associated with an ad, navigating to the location associated with the ad, or walking to the location associated with the ad) or a click-through related to an ad (e.g., a user has selected an ad) has occurred. This usage information can include measured or observed user behavior related to ads that have been served. In some cases, a user may enable and/or disable the recording or observation of such usage information. In some cases, identifiers associated with each user may be anonymized so that the identity of each user is not provided to the advertiser. The system 104 can perform financial transactions, for example, crediting the publishers 106 and charging the advertisers 102 based on the usage information.

A network 110, such as a local area network (LAN), wide area network (WAN), the Internet, one or more telephony networks or a combination thereof, connects the advertisers 102, the system 104, the publishers 106, and the users 108.

One example publisher 106 is a general content server that receives requests for content (e.g., articles, discussion threads, music, video, graphics, search results, web page listings, information feeds, etc.), and retrieves the requested content in response to the request. The content server can submit a request for content such as ads to a content server such as an advertisement server in the system 104. The ad request can include a number of ads desired. The ad request can also include content request information. This information can include the content itself (e.g., page, video broadcast, radio show, or other type of content), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server or a client browser can combine the requested content with one or more of the ads provided by the system 104. The combined content and ads can be sent/rendered to the users 108 that requested the content for presentation in a viewer (e.g., a browser or other content display system). The content server can transmit information about the ads back to the content server, including information describing how, when, and/or where the ads are to be rendered (e.g., in HTML or JavaScript™)

Another example publisher 106 is a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and can be grouped into a predetermined number of (e.g., ten) search results.

The search service can submit a request for ads to the system 104. The request can include a number of ads desired. This number can depend on the search results, the amount of screen or page space occupied by the search results, the size and shape of the ads, and/or a variety of other factors. In some implementations, the number of desired ads will be from one to ten, or from three to five. The request for ads can also include the query (as entered or parsed), information based on the query (such as geo-location information, whether the query came from an affiliate and an identifier of such an affiliate), and/or information associated with, or based on, the search results. Such information can include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

In some implementations, the content management system 104 includes an auction process to select ads from the advertisers 102. For example, the advertisers 102 can be permitted to select, or bid, an amount the advertisers are willing to pay for each presentation of or interaction with (e.g., click of) an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the system 104. This combined information can then be forwarded to the users 108 that requested the content. The search results can be maintained as distinct from the ads, so as not to confuse the user between paid ads and presumably neutral search results.

In some implementations, one or more publishers 106 can submit requests for ads to the advertising management system 104. The system 104 responds by sending ads to the requesting publisher 106 for placement on one or more of the publisher's web properties (e.g., websites and other network-distributed content) that are relevant to the web property. For example, if a publisher 106 publishes a sports-related web site, the advertising management system can provide sports-related ads to the publisher 106. In some implementations, the requests can instead be executed by devices associated with the user 108, e.g., by the execution of a particular script when the publisher's web page is loading on a client device.

In some alternative implementations, an ad push model is used to provide ads from advertisers 102. In an ad push model, ads can be pushed to idle screens (e.g., of a mobile devices or particular applications) based on particular criteria (e.g., the user's location).

In another example publisher 106 is a mobile application developer. A mobile application is an application specifically designed for operation on a mobile device (e.g., a smart phone). The mobile application can also include ads positioned within the content of the mobile application. Similar to publishers 106, the ads can be received from the system 104 for placement in the mobile application when accessed by a user (e.g., when a particular page of a mobile application is loaded on the mobile device).

For situations in which the systems discussed here collect personal information about users, the users may be provided with an opportunity to opt in/out of programs or features that may collect personal information (e.g., information about a user's preferences or a user's current location). User may also be informed of the accompanying limitations on the functionality of a service that may result from limiting access to such personal information. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, zip code, or state level), so that a particular location of a user cannot be determined.

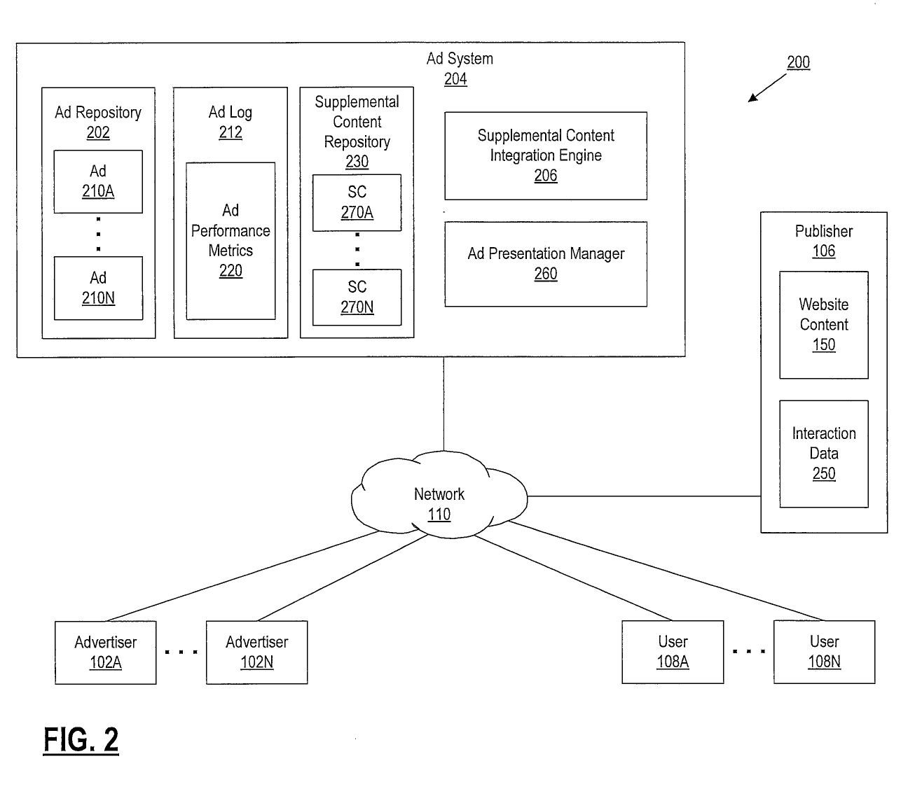

FIG. 2 is a block diagram of an example system 200 for integrating content within a webpage. In the system 200, an advertiser 102A-102N (referred to collectively as advertisers 102) can submit one or more ads 210A-210N (also known as “creatives”) (referred to collectively as ads 210) to an ad system 204, and such ads 210 are stored in an ad repository 202. Each ad (e.g., ad 210A) includes one or more words, phrases, web links, and/or any other such element and/or component (e.g., images, video, audio, etc.) that are provided to one or more users 108 (e.g., banner ads, text-only ads, image ads, audio ads, video ads, etc.). In certain implementations, one or more keywords (not shown) are associated with one or more creatives in order to enable the identification and selection of pertinent ads for display to a user based on one or more search queries received from the user. It should also be noted that although ads 210 are described herein as referring to individual ads, in certain implementations ads 210 can refer to groups of ads, such as ad groups, campaigns, and/or categories.

Ad system 204 can also include an ad presentation manager 260. The ad presentation manager 260 can identify ads in the ad repository 202 to present to a user 108, for example based on various criteria such as keywords in a search query, web page content, context, location, ad financials (e.g., cost per impression). For example, ad presentation manager 260 can identify one or more ads 210 associated with one or more keywords that are similar and/or identical to the search query provided by the user, and such creatives can be provided to the user in any number of ad formats. It should be understood that in some implementations, the ad system 204 can interact with a search system, for example presenting ads alongside search results. In some implementations, the ad system 204 can interact with content publishers, for example, providing ads to publishers or users for presentation along with web content, e-mail, or other content.

Ad system 204 can also include one or more ad logs 212. Ad log 212 can track and store one or more ad performance metrics 220 that reflect the performance or success of a particular ad. For example, for a given ad, ad log 212 can track the ‘click through rate,’(CTR) reflecting the percentage of users presented with an ad that click on or otherwise select the presented content, though it should be understood that any number of other performance metrics can be similarly tracked (e.g., conversion rate), as is known to those of ordinary skill in the art.

Ad system 204 can also include a supplemental content repository 230 that stores one or more supplemental content items 270A-270N (referred to collectively as supplemental content items 270). Such supplemental content items 270 can include various forms of data and/or media that can be inserted into a webpage in lieu of an ad 210, such as in the manner described in detail herein.

At this juncture it should be noted that while FIG. 2 depicts supplemental content repository 230 within ad system 204, in alternate implementations supplemental content repository 230 can be configured external to ad system 204, such as at publisher 106. In such an alternate implementation, publisher 106 can optionally exercise additional control over supplemental content repository 230.

Additionally, ad system 204 can include a supplemental content integration engine 206. The supplemental content integration engine 206 can deploy various supplemental content items 270, and/or arrangements thereof, within webpages that are served to users 108. Such supplemental content items 270, and/or arrangements thereof can be deployed in a manner that serves to equalize the collective distribution of the attention of one or more users across the webpage, as described in detail herein. It should also be understood that in some implementations supplemental content integration engine 206 can include one or more processors configured by code to implement the functionality of the supplemental content integration engine that is being described.

As described above, one or more publishers 106 can be in communication with ad system 204 through network 110. In certain implementations, publishers 106 can maintain website content 150 and interaction data 250. Interaction data 250 reflects, for example, various instances of interaction that users 108 initiate and/or maintain in relation to website content 150, ads 210, and/or supplemental content items 270. Examples of such interactions include but are not limited to instances of clicking, cursor hovering, scrolling, and/or user focus/interest (e.g., as utilized in eye-tracking ‘heatmaps,’ as are known to those of ordinary skill in the art) in relation to one or more webpages. It should also be noted that while FIG. 2 depicts interaction data 250 as being maintained at publisher 106, in other implementations interaction data 250 can be maintained external to publisher 106, such as at ad system 204.

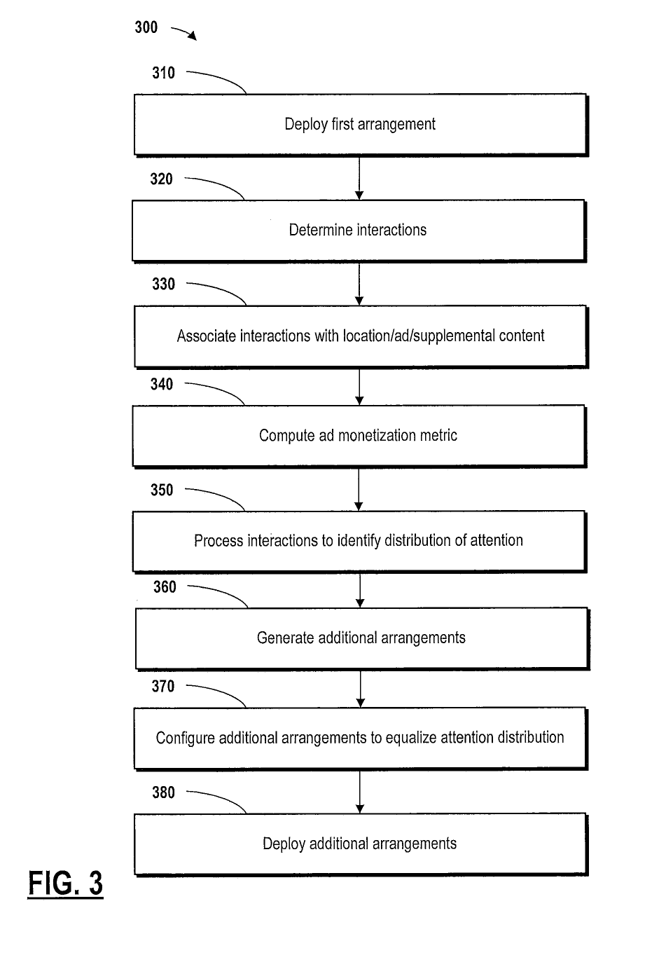

FIG. 3 is a flowchart of an example method 300 for integrating content within a webpage. In some implementations, the method 300 can be performed by a processor executing instructions in a computer-readable storage medium. For example, the method 300 can be performed by the ad system 204 of FIG. 2.

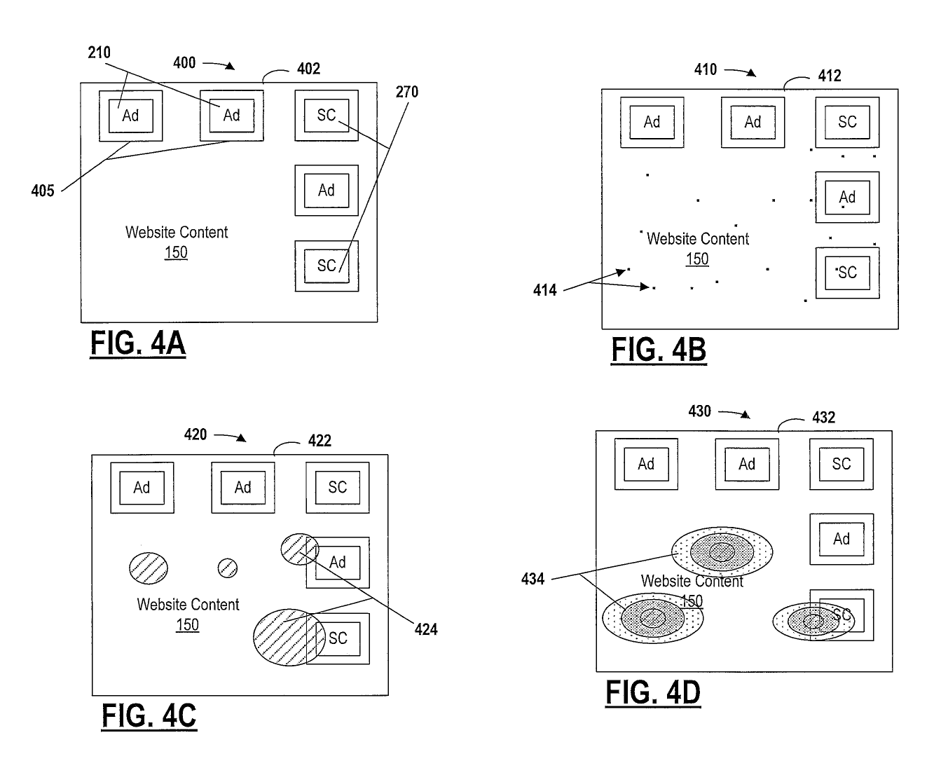

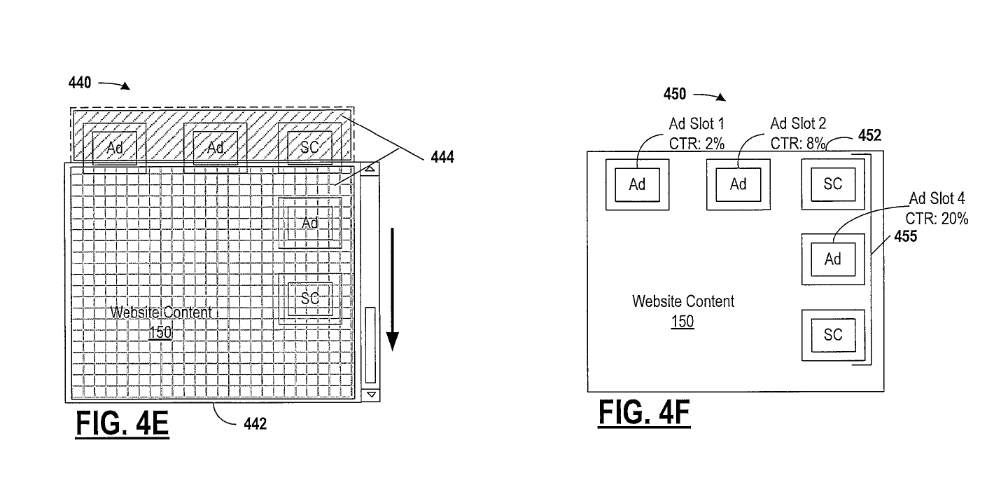

A first arrangement of supplemental content items is deployed across one or more ad slots of a webpage (310). It should be understood that, in certain implementations, the referenced ad slots include one or more locations within the webpage that are designated or reserved for the placement of ads. For example, FIG. 4A depicts an exemplary screenshot 400, reflecting an exemplary webpage 402 provided by publisher 106 to user 108. Webpage 402 includes website content 150 (e.g., HTML code operative to render text, embedded media, hyperlinks, etc. in a web browser) and various ad slots 405 situated in specific locations within the webpage 402. It can be appreciated that the ad slots of webpage 402 are arranged along the top and right-hand sides of the webpage, forming what can be referred to as ‘panels’ (e.g., a ‘top panel,’ a ‘right-hand panel,’ etc.). It can be further appreciated with reference to FIG. 4A that certain of the ad slots 405 are occupied by ads 210, while other ad slots are occupied by supplemental content items (‘SC’) 270. The particular ad slots within which the supplemental content items are deployed can be said to be the arrangement of the supplemental content items within the webpage. As described herein, supplemental content items are integrated within certain ad slots in order to increase utilization of the entire area of a webpage and to encourage website users to pay closer attention to the content found within the ad slots.

Interactions are determined in relation to a webpage (320). As referenced above, in certain implementations, such interactions correspond to instances of interaction that one or more users 108 (such as group or set of users) initiate and/or maintain in relation to website content 150, ads 210, and/or supplemental content items 270. For example, FIG. 4B depicts an exemplary screenshot 410, showing locations of one or more user clicks 414 across an exemplary webpage 412. By way of further example, FIG. 4C depicts an exemplary screenshot 420, showing locations and degrees of intensity (e.g., lengths of time) of cursor movement/hovering 424 across an exemplary webpage 422. By way of further example, FIG. 4D depicts an exemplary screenshot 430, showing ‘heatmaps’ 434 across an exemplary webpage 432, reflecting locations and degrees of intensity of user focus or interest. By way of further example, FIG. 4E depicts an exemplary screenshot 440, showing areas of exposure 444 within an exemplary webpage 442, as reflected by various instances of scrolling of the webpage 442 by one or more users (such as group or set of users).

Moreover, in certain implementations, various ad performance metrics corresponding to the ads deployed across the one or more ad slots are determined. For example, FIG. 4F depicts an exemplary screenshot 450 of an exemplary webpage 452, indicating the click-through rate (CTR) of the various ad slots containing ads (Ad Slot 1, Ad Slot 2, and Ad Slot 4) as deployed within arrangement 455 (reflecting the insertion of supplemental content items in Ad Slot 3 and Ad Slot 5) across webpage 452. It can be appreciated with reference to FIG. 4F that within arrangement 455, ads deployed in Ad Slot 4, having supplemental content items 270 on either side, have a substantially higher CTR than ads deployed in Ad Slot 1 which is not situated adjacent to any supplemental content items (20% vs. 2%).

The interactions are associated with one or more related items (330). For example, in certain implementations the interactions can be associated with a location within the webpage, an ad, and/or a supplemental content item. That is, upon determining the various interactions (clicks, cursor hovering, etc.) in relation to a webpage, such interactions can be associated with the various items or aspects of the webpage to which they pertain/relate. By way of illustration, the various clicks 414 depicted in FIG. 4B can be associated with a location within the webpage (e.g., pixel coordinates and/or a relative location at which each click occurred) and/or the particular webpage component (e.g., website content, supplemental content item, and/or ad) to which each particular click corresponds. It can be appreciated that such an association enables further analysis and insight with respect to the significance of a particular interaction (e.g., the ability to distinguish between a click occurring at an ad slot containing an ad and a click occurring at the same ad slot in a scenario when a supplemental content item has been inserted into the ad slot in lieu of an ad).

Ad monetization metrics for the webpage are computed (340). In certain implementations, such ad monetization metrics are computed based on the one or more ad performance metrics (such as those determined at 320). That is, it can be appreciated that a monetization rate (e.g., an amount of advertising revenue a webpage is expected to generate for a given visit) for a given arrangement can be computed based on the various ad performance metrics for each of the ad slots within the arrangement in which ads (as opposed to supplemental content items) are deployed. Moreover, it can be appreciated that in many scenarios, simply increasing the number of ad slots in which ads are deployed does not necessarily increase the overall monetization rate of the page.

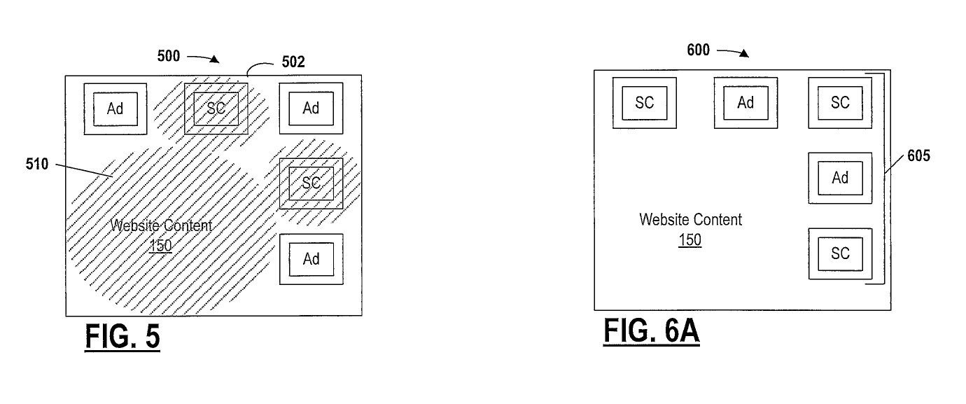

The interactions are processed (350). In doing so, a collective distribution (e.g., an overall and/or average distribution) of attention across the webpage can be identified. For example, the various interactions depicted in FIGS. 4B-F and described in detail above can be processed in order to identify how the attention of one or more users (such as group or set of users) is collectively distributed across the webpage with respect to the various arrangements of supplemental content deployed within each page. By way of illustration, FIG. 5 depicts an exemplary screenshot 500 of an exemplary webpage 502 overlaid with a depiction of the collective distribution of attention 510 across the page. It can be appreciated that various interactions, such as those determined at 320 (e.g., clicks, cursor hovering, etc.), and/or a combination thereof, can be used to identify the areas of the webpage 502 that do (or do not) attract and/or maintain the attention of one or more users (such as group or set of users). It can be further appreciated with reference to FIG. 5 that the attention 510 in this scenario is collectively distributed across the areas of website 502 containing website content 150 and supplemental content items 270 (and does not extend to the areas containing ads 210).

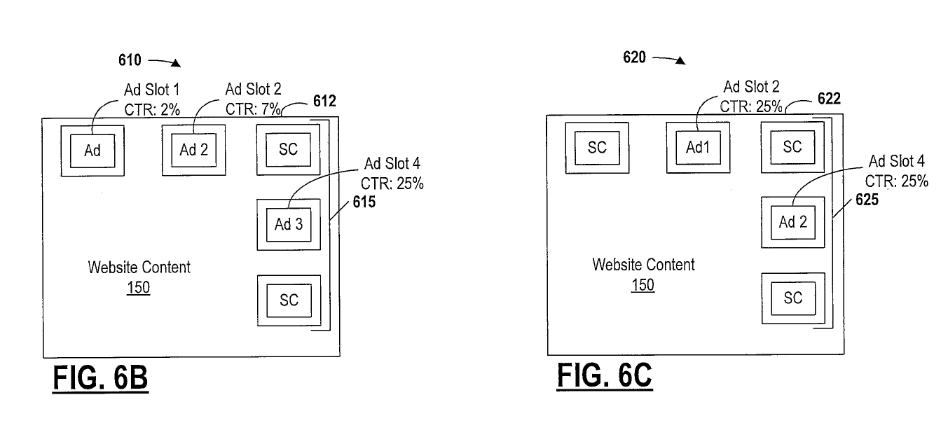

Additional arrangements of supplemental content items are generated (360). In certain implementations, such additional arrangements are generated based on a collective distribution of attention (such as the distribution identified at 350). That is, it can be appreciated with reference to FIG. 5 that while attention 510 extends to the areas of webpage 502 containing supplemental content items 270, attention 510 does not extend to the areas of webpage 502 containing ads 210 (e.g., the upper left-hand, upper right hand, and lower right-hand corners of the webpage). As such, one or more additional arrangements of supplemental content items 270 can be generated, whereby supplemental content items 270 can be positioned within the webpage in a manner that more evenly distributes attention 510 across the entire page. For example, FIG. 6A depicts an exemplary screenshot 600 of one such exemplary arrangement 605 of supplemental content items 270. It can be appreciated that, in light of the lack of attention 510 reflected in upper left-hand, upper right hand, and lower right-hand corners of the webpage 502 of FIG. 5, in arrangement 605 of FIG. 6, supplemental content items can be placed in those corners, in order to increase the attention in those areas.

Moreover, in certain implementations the additional arrangements of supplemental content items are generated based on ad monetization metrics (such as those computed at 340). For example, FIG. 6B depicts an exemplary screenshot 610 of an exemplary webpage 612 indicating the click-through rate (CTR) of the various ad slots containing ads (Ad Slot 1, Ad Slot 2, and Ad Slot 4) as deployed within arrangement 615 (reflecting the insertion of supplemental content items in Ad Slot 3 and Ad Slot 5) across webpage 612. It can be appreciated with reference to FIG. 6B that Ad Slot 4, being adjacent to supplemental content items 270 on two sides, has a substantially higher CTR (25%) than both Ad Slot 2 (being adjacent to only one supplemental content item 270 and having a CTR of 7%) and Ad Slot 1 (being adjacent to no supplemental content items 270 and having a CTR of 2%). Taking into account the ad monetization metrics reflected by these ad performance metrics (e.g., an amount of advertising revenue a webpage with arrangement 615 is expected to generate for a given visit), additional arrangements of supplemental content items can be generated. For example, FIG. 6C depicts an exemplary screenshot 620 of an exemplary arrangement 625 of supplemental content items 270 within webpage 622, and also indicates the click-through rate (CTR) of each of the ad slots within the arrangement in which ads are deployed (Ad Slot 2 and Ad Slot 4). It can be appreciated that as a result of the deployment of arrangement 625, both Ad Slot 2 and Ad Slot 4 are adjacent to supplemental content items 270 on two sides, further resulting in ads deployed within those ad slots of having a CTR of 25%. Accordingly, it can be appreciated that the arrangement 625 of supplemental content items depicted in webpage 622 of FIG. 6C (that is, inserting supplemental content items into Ad Slots 1, 3, and 5) is likely to generate a more advertising revenue for a given visit than the arrangement 615 depicted in webpage 612 of FIG. 6B (wherein supplemental content items are inserted into Ad Slots 3 and 5 only), despite including a fewer total number of ads.

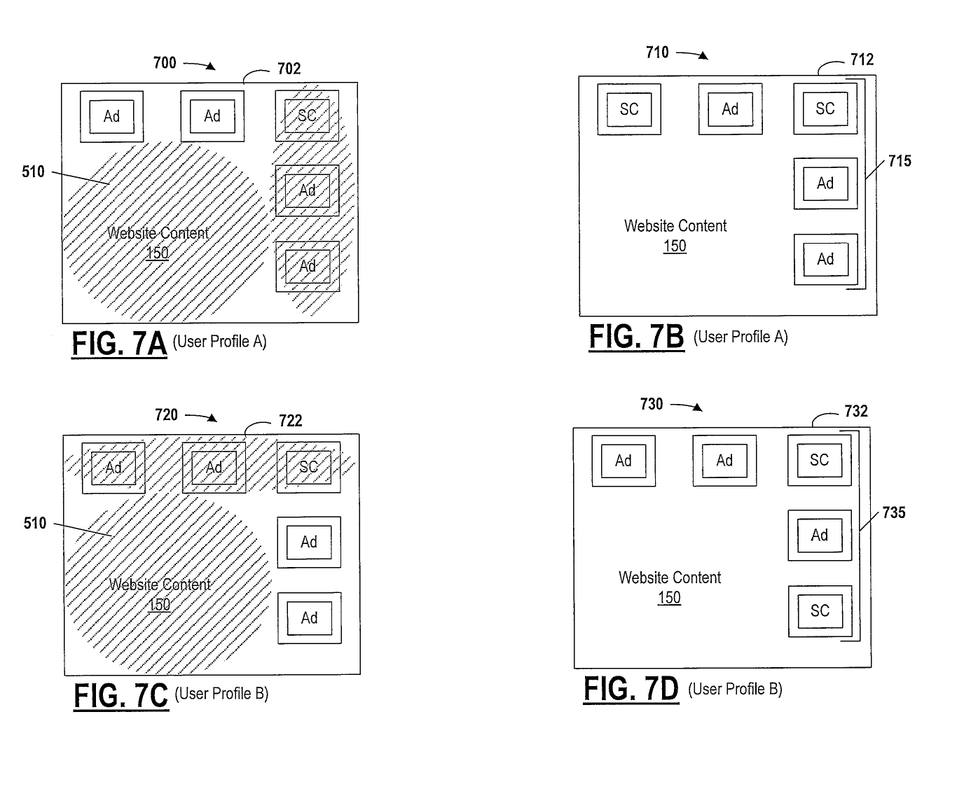

Moreover, in certain implementations additional arrangements of supplemental content items can be generated based on user profiles that identify or reflect characteristics associated with various types of users. That is, it can be appreciated that different users having different user profiles (e.g., being members of different demographics or groups, having different interests, etc., as can be identified/tracked, based on a user account, browsing history, etc., and/or other methods known to those of ordinary skill in the art) can interact with the same webpage in different ways, resulting in different collective distributions of attention across the webpage. For example, the attention of users within the age range of 55-65 might gravitate more towards the bottom or side of a webpage, while the attention of users within the age range of 18-25 might gravitate more towards the top of the same page. By way of illustration, FIG. 7A depicts an exemplary screenshot 700 of an exemplary webpage 702 having a supplemental content item 270 oriented in the upper right-hand corner of the webpage. FIG. 7A further depicts webpage 702 being overlaid with a depiction of the collective distribution of attention 510 corresponding to User Profile A (e.g., users between the ages of 55-65), reflecting that users associated with User Profile A pay relatively more attention to the bottom right-hand corner of webpage 702 than to the upper left-hand corner of webpage 702 (despite the fact that the two areas both contain ads and are both equidistant from supplemental content item 270 and website content 150). Similarly, FIG. 7C depicts an exemplary screenshot 720 of an exemplary webpage 722 which is substantially similar to that of webpage 702 of FIG. 7A. However, it can be appreciated that webpage 722 of FIG. 7C is overlaid with a depiction of the collective distribution of attention 510 corresponding to User Profile B (e.g., users between the ages of 18-25), reflecting that users associated with User Profile B pay relatively more attention to the upper left-hand corner of webpage 702 than to the bottom right-hand corner of webpage (despite the fact that the two areas both contain ads and are both equidistant from supplemental content item 270 and website content 150). Accordingly, in order to account for differences between different user profiles with respect to collective distributions of attention across the same webpage, additional arrangements of supplemental content items can be generated based on a user profile. Thus, for example, FIG. 7B depicts an exemplary screenshot 710 of one such arrangement 715 of supplemental content items 270, wherein an additional supplemental content item can be inserted in the upper left-hand corner of the webpage 712, on account of the lack of attention distributed in this area, as reflected in FIG. 7A. Similarly, FIG. 7D depicts an exemplary screenshot 730 of an arrangement 735 of supplemental content items 270, wherein an additional supplemental content item is inserted in the lower right-hand corner of the webpage 732, on account of the lack of attention distributed in this area, as reflected in FIG. 7C.

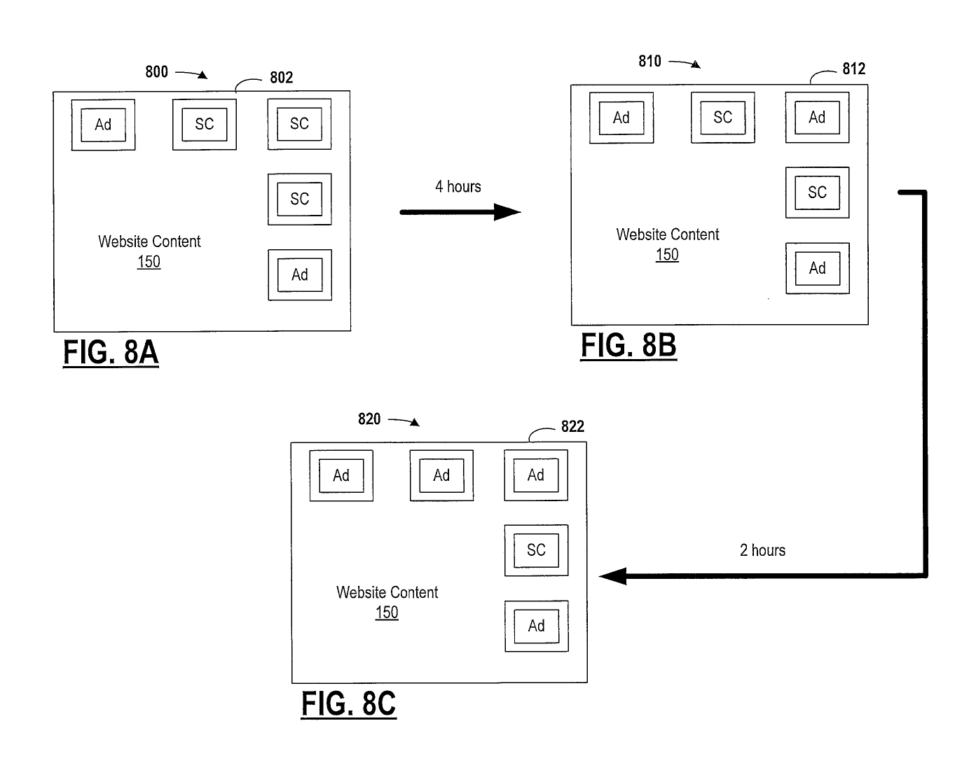

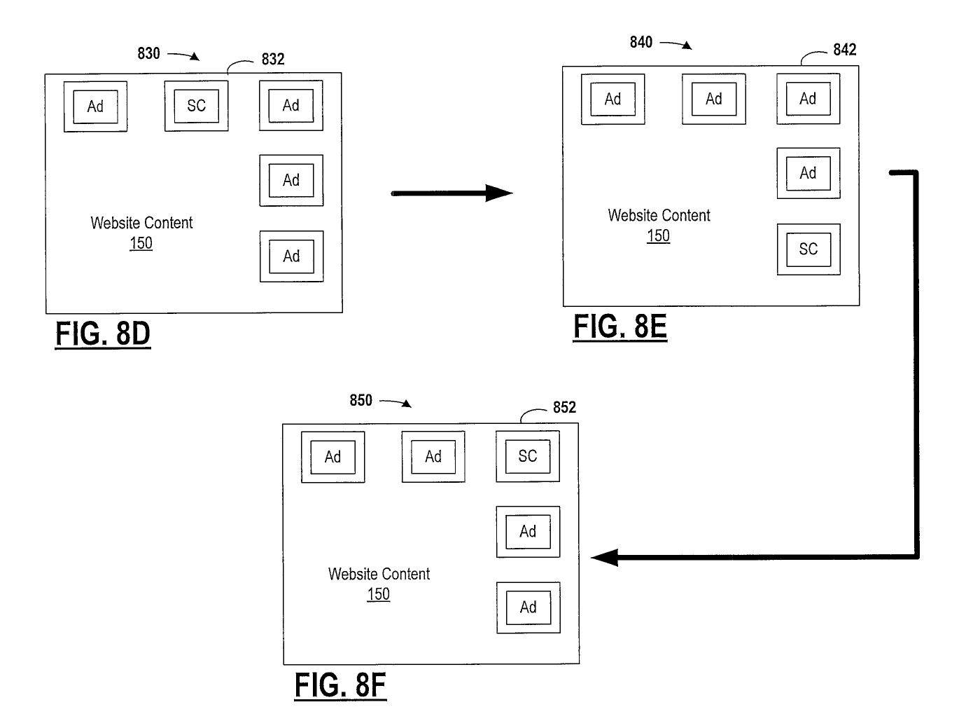

One or more of the additional arrangements are configured to equalize the collective distribution of attention across the webpage (370). That is, it can be appreciated that in many cases, users can become conditioned to practically any static arrangement of ads and supplemental content items, such that if users become accustomed to a particular arrangement, they may consciously or subconsciously begin to ignore the ads being provided. As such, it can be desirable to dynamically adjust various aspects of the deployment of the ads and/or the supplemental content items, such that the user is not so conditioned, and the attention of the user is drawn equally to all areas of a particular webpage (e.g., on account of the supplemental content items) at different intervals. By way of example, in certain implementations, the additional arrangements of supplemental content items (such as those generated at 360) can be configured to deploy at dynamically adjusted time intervals. FIGS. 8A-C illustrate one such deployment scheme. FIG. 8A depicts an exemplary screenshot 800 of an exemplary webpage 802 showing an arrangement of three supplemental content items 270 within the webpage. After a certain time interval has elapsed (e.g., four hours, as shown, reflecting the total amount of time a user has spent on the page, the total amount of time since the user first visited the page, and/or an ongoing timer that operates independently of user behavior), the arrangement of FIG. 8A can be configured to transition into the arrangement reflected in FIG. 8B, showing an arrangement of two supplemental content items 270 within the webpage. Similarly, after yet another time interval (e.g., two hours, as shown), the arrangement of FIG. 8B can be configured to transition into the arrangement reflected in FIG. 8C, showing an arrangement of one supplemental content items 270 within the webpage. After yet another time interval, the sequence shown in FIGS. 8A-C can repeat. It can be appreciated that having drawn the attention of a user to certain areas of a webpage by way of the insertion of supplemental content items, over time ads can gradually be reintroduced into these areas in a manner that is likely to result in improved performance of the ad(s), on account of the increase in attention. At the same time, being that maintaining ads in the same locations over an extended period of time can result in decreasing attention, supplemental content items can be reintroduced to these areas in a cyclical fashion in order to maintain a certain degree of attention over item.

Moreover, in other implementations, the additional arrangements of supplemental content items (such as those generated at 360) can be configured to be deployed at dynamically changing locations within a webpage. By way of example, FIGS. 8D-F illustrate one such deployment scheme. FIG. 8D depicts an exemplary screenshot 830 of an exemplary webpage 832 showing an arrangement of a supplemental content item 270 at a first location within the webpage. In order to draw the attention of a user to other locations within the webpage (e.g., those locations that otherwise contain ads), the location of supplemental content item 270 can be dynamically changed or shifted, such as in the arrangements reflected in FIGS. 8E and 8F. In doing so, the attention of a user is drawn to various locations across the webpage (on account of the changing location of the supplemental content item), thereby resulting a more even or equalized distribution of attention across the entire webpage.

One or more of the additional arrangements are deployed across the ad slots of the webpage (380). That is, when serving the webpage to one or more users (such as users among a particular group or set of users), the various supplemental content items can be inserted within ad slots 405 of the page based on the various arrangements of supplemental content items, such as those generated at 360 and/or configured at 370. It can be appreciated that while multiple arrangements of supplemental content items can be generated, in certain implementations, the arrangements are deployed based on the one or more ad monetization metrics (such as those computed at 340). For example, if an existing arrangement is determined to generate a certain amount of advertising revenue for a given visit, only arrangements that can be projected to increase the amount of advertising revenue per visit are deployed, as can be appreciated with reference to FIGS. 6B-C and as described at 360. Moreover, in certain implementations, the additional arrangements can be deployed based on user profiles. For example, as described at 360 and illustrated in FIGS. 7A-B and 7C-D, in certain implementations various arrangements can be generated for different user profiles, however, only those arrangements associated with a particular user profile will be deployed to users matching that profile.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

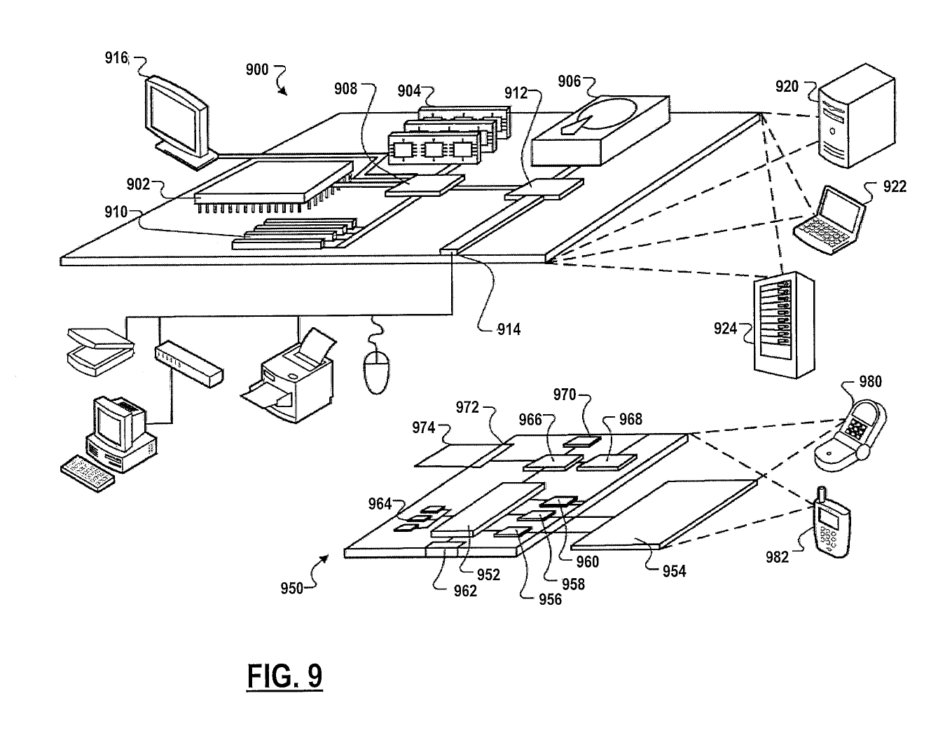

FIG. 9 shows an example of a computing device 900 and a mobile computing device that can be used to implement the techniques described herein the present specification. The computing device 900 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and can be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 can also be another form of computer-readable medium, such as a magnetic or optical disk.

The storage device 906 is capable of providing mass storage for the computing device 900. In some implementations, the storage device 906 can be or contain a computer-readable medium, e.g., a computer-readable storage medium such as a floppy disk device, a hard disk device, an optical disk device, or a tape device, a flash memory or other similar solid state memory device, or an array of devices, including devices in a storage area network or other configurations. A computer program product can also be tangibly embodied in an information carrier. The computer program product can also contain instructions that, when executed, perform one or more methods, such as those described above. The computer program product can also be tangibly embodied in a computer- or machine-readable medium, such as the memory 904, the storage device 906, or memory on the processor 902.

The high-speed interface 908 manages bandwidth-intensive operations for the computing device 900, while the low-speed interface 912 manages lower bandwidth-intensive operations. Such allocation of functions is exemplary only. In some implementations, the high-speed interface 908 is coupled to the memory 904, the display 916 (e.g., through a graphics processor or accelerator), and to the high-speed expansion ports 910, which can accept various expansion cards (not shown). In the implementation, the low-speed interface 912 is coupled to the storage device 906 and the low-speed expansion port 914. The low-speed expansion port 914, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 900 can be implemented in a number of different forms, as shown in the figure. For example, it can be implemented as a standard server 920, or multiple times in a group of such servers. In addition, it can be implemented in a personal computer such as a laptop computer 922. It can also be implemented as part of a rack server system 924. Alternatively, components from the computing device 900 can be combined with other components in a mobile device (not shown), such as a mobile computing device 950. Each of such devices can contain one or more of the computing device 900 and the mobile computing device 950, and an entire system can be made up of multiple computing devices communicating with each other.

The mobile computing device 950 includes a processor 952, a memory 964, an input/output device such as a display 954, a communication interface 966, and a transceiver 968, among other components. The mobile computing device 950 can also be provided with a storage device, such as a micro-drive or other device, to provide additional storage. Each of the processor 952, the memory 964, the display 954, the communication interface 966, and the transceiver 968, are interconnected using various buses, and several of the components can be mounted on a common motherboard or in other manners as appropriate.

The processor 952 can execute instructions within the mobile computing device 950, including instructions stored in the memory 964. The processor 952 can be implemented as a chipset of chips that include separate and multiple analog and digital processors. The processor 952 can provide, for example, for coordination of the other components of the mobile computing device 950, such as control of user interfaces, applications run by the mobile computing device 950, and wireless communication by the mobile computing device 950.

The processor 952 can communicate with a user through a control interface 958 and a display interface 956 coupled to the display 954. The display 954 can be, for example, a TFT (Thin-Film-Transistor Liquid Crystal Display) display or an OLED (Organic Light Emitting Diode) display, or other appropriate display technology. The display interface 956 can comprise appropriate circuitry for driving the display 954 to present graphical and other information to a user. The control interface 958 can receive commands from a user and convert them for submission to the processor 952. In addition, an external interface 962 can provide communication with the processor 952, so as to enable near area communication of the mobile computing device 950 with other devices. The external interface 962 can provide, for example, for wired communication in some implementations, or for wireless communication in other implementations, and multiple interfaces can also be used.

The memory 964 stores information within the mobile computing device 950. The memory 964 can be implemented as one or more of a computer-readable medium or media, a volatile memory unit or units, or a non-volatile memory unit or units. An expansion memory 974 can also be provided and connected to the mobile computing device 950 through an expansion interface 972, which can include, for example, a SIMM (Single In Line Memory Module) card interface. The expansion memory 974 can provide extra storage space for the mobile computing device 950, or can also store applications or other information for the mobile computing device 950. Specifically, the expansion memory 974 can include instructions to carry out or supplement the processes described above, and can include secure information also. Thus, for example, the expansion memory 974 can be provide as a security module for the mobile computing device 950, and can be programmed with instructions that permit secure use of the mobile computing device 950. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 964, the expansion memory 974, or memory on the processor 952. In some implementations, the computer program product can be received in a propagated signal, for example, over the transceiver 968 or the external interface 962.

The mobile computing device 950 can communicate wirelessly through the communication interface 966, which can include digital signal processing circuitry where necessary. The communication interface 966 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 968 using a radio-frequency. In addition, short-range communication can occur, such as using a Bluetooth, WiFi, or other such transceiver (not shown). In addition, a GPS (Global Positioning System) receiver module 970 can provide additional navigation- and location-related wireless data to the mobile computing device 950, which can be used as appropriate by applications running on the mobile computing device 950.

The mobile computing device 950 can also communicate audibly using an audio codec 960, which can receive spoken information from a user and convert it to usable digital information. The audio codec 960 can likewise generate audible sound for a user, such as through a speaker, e.g., in a handset of the mobile computing device 950. Such sound can include sound from voice telephone calls, can include recorded sound (e.g., voice messages, music files, etc.) and can also include sound generated by applications operating on the mobile computing device 950.

The mobile computing device 950 can be implemented in a number of different forms, as shown in the figure. For example, it can be implemented as a cellular telephone 980. It can also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable storage medium and computer-readable storage medium refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term machine-readable signal refers to any signal used to provide machine instructions and/or data to a programmable processor. A machine-readable storage medium does not include a machine-readable signal.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method for integrating supplemental content within a webpage, the method comprising:
deploying a first arrangement of supplemental content items across one or more ad slots within an area of a webpage;
determining one or more interactions in relation to the webpage;
processing, with a processor executing code, the one or more interactions to identify a collective distribution of attention across the area of the webpage;
generating, based on the collective distribution, one or more additional arrangements of supplemental content items, and
deploying at least one of the one or more additional arrangements across the one or more ad slots within the area of the webpage, wherein supplemental content items are deployed in lieu of one or more ads.

2. The method of claim 1, wherein the one or more ad slots comprise one or more locations within the area of the webpage.

3. The method of claim 1, wherein the determining step comprises determining one or more ad performance metrics of one or more ads deployed across the one or more ad slots.

4. The method of claim 3, further comprising computing one or more ad monetization metrics for the webpage based on the one or more ad performance metrics.

5. The method of claim 4, wherein the one or more additional arrangements are generated based on the one or more ad monetization metrics.

6. The method of claim 4, wherein the one or more additional arrangements are deployed based on the one or more ad monetization metrics.

7. The method of claim 1, further comprising associating one or more interactions with at least one of (a) a location within the webpage, (b) an ad, and (c) a supplemental content item.

8. The method of claim 1, wherein the one or more interactions comprises at least one of (a) one or more clicks, (b) one or more instances of cursor hovering, (c) one or more instances of scrolling, and (d) one or more instances of user eye movement.

9. The method of claim 1, further comprising configuring the one or more additional arrangements to equalize the collective distribution of attention across the area of the webpage.

10. The method of claim 9, wherein the configuring step comprises configuring the one or more additional arrangements to deploy at dynamically adjusted intervals.

11. The method of claim 9, wherein the configuring step comprises configuring the one or more additional arrangements to deploy at dynamically changing locations within the area of the webpage.

12. The method of claim 1, wherein the one or more additional arrangements are generated based on a user profile.

13. The method of claim 1, wherein the one or more additional arrangements are deployed based on a user profile.

14. A system comprising: one or more processors configured to interact with a computer-readable medium in order to perform operations comprising:
deploying a first arrangement of supplemental content items across one or more ad slots within an area of a webpage;
determining one or more interactions in relation to the webpage;
processing the one or more interactions to identify a collective distribution of attention across the area of the webpage;
generating, based on the collective distribution, one or more additional arrangements of supplemental content items, and
deploying at least one of the one or more additional arrangements across the one or more ad slots within the area of the webpage, wherein supplemental content items are deployed in lieu of one or more ads.

15. The system of claim 14, wherein the one or more ad slots comprise one or more locations within the area of the webpage.

16. The system of claim 14, wherein the determining operation comprises determining one or more ad performance metrics of one or more ads deployed across the one or more ad slots.

17. The system of claim 16, further configured to perform operations comprising computing one or more ad monetization metrics for the webpage based on the one or more ad performance metrics.

18. The system of claim 17, wherein the one or more additional arrangements are generated based on the one or more ad monetization metrics.

19. The system of claim 17, wherein the one or more additional arrangements are deployed based on the one or more ad monetization metrics.

20. The system of claim 14, further configured to perform operations comprising associating one or more interactions with at least one of (a) a location within the webpage, (b) an ad, and (c) a supplemental content item.

21. The system of claim 14, wherein the one or more interactions comprises at least one of (a) one or more clicks, (b) one or more instances of cursor hovering, (c) one or more instances of scrolling, and (d) one or more instances of user eye movement.

22. The system of claim 14, further configured to perform operations comprising configuring the one or more additional arrangements to equalize the collective distribution of attention across the area of the webpage.

23. The system of claim 22, wherein the configuring operation comprises configuring the one or more additional arrangements to deploy at dynamically adjusted intervals.

24. The system of claim 22, wherein the configuring operation comprises configuring the one or more additional arrangements to deploy at dynamically changing locations within the area of the webpage.

25. The system of claim 14, wherein the one or more additional arrangements are generated based on a user profile.

26. The system of claim 14, wherein the one or more additional arrangements are deployed based on a user profile.

27. A non-transitory computer storage medium encoded with a computer program, the program comprising instructions that when executed by a data processing apparatus cause the data processing apparatus to perform operations comprising:
deploying a first arrangement of supplemental content items across one or more ad slots within an area of a webpage;
determining one or more interactions in relation to the webpage;
processing the one or more interactions to identify a collective distribution of attention across the area of the webpage;
generating, based on the collective distribution, one or more additional arrangements of supplemental content items,
configuring the one or more additional arrangements to equalize the collective distribution of attention across the webpage; and
deploying at least one of the one or more additional arrangements across the one or more ad slots within the area of the webpage, wherein supplemental content items are deployed in lieu of one or more ads.
